(19) United States
(12) Patent Application Publication
(10) Pub. No.: US 2026/0257430 A1
(43) Pub. Date: Sep. 3, 2026

(54) MICROPOROUS SHAPES AND PROCESSES FOR MANUFACTURE THEREOF

(71) Applicant: Board of Regents, The University of Texas System, Austin, TX (US)

(72) Inventors: Alexis Maurel, El Paso, TX (US); Abraham Enchinton, El Paso, TX (US); Katherine R. Gonzalez, El Paso, TX (US); Ana C. Martinez Maciel, El Paso, TX (US)

(21) Appl. No.: 19/555,110

(22) Filed: Mar. 3, 2026

Related U.S. Application Data
(60) Provisional application No. 63/766,116, filed on Mar. 3, 2025.

(51) Int. Cl. B29C 67/20; B29K 23/00; B29L 31/34; H01M 50/403; H01M 50/417

(52) U.S. Cl. CPC B29C 67/202; B29C 67/205; H01M 50/403; H01M 50/417; B29K 2023/12; B29L 2031/3468

(57) ABSTRACT

Additive manufacturing processes allow the development of custom-shape rechargeable batteries. Appearing as one of the key-components of lithium-ion batteries, this work is specifically focused on the manufacturing of highly porous separators with any complex geometry, facilitated by the filament material extrusion 3D printing process. This study discusses the development and optimization of a composite thermoplastic filament feedstock combining polypropylene and paraffin wax, followed by the 3D printing of the biphasic separator membranes. A post-processing step, based on Thermal Induced Phase Separation (TIPS), is introduced to promote the microporosity formation through the removal of the paraffin wax sacrificial material within the 3D printed samples thanks to a solvent. Separators with different polypropylene/paraffin wax ratio are developed and the need for a compromise between printability, mechanical strength, final porosity, and electrochemical performances, is thoroughly discussed.

### CROSS-REFERENCE TO RELATED APPLICATION

This application claims the benefit of U.S. Provisional Patent Application Ser. No. 63/766,116, filed Mar. 3, 2025, and entitled “Microporous Shapes and Processes for Manufacture Thereof,” which is incorporated herein by reference in its entirety.

### BACKGROUND

Since their commercialization in 1991, lithium-ion batteries (LIB) have grown in ubiquity with applications including but not limited to modern portable electronics, aerospace systems, electric and hybrid vehicles, and even large-scale energy storage systems. While their application breadth and demand continue to grow, commercial battery geometry has remained relatively unchanged: a planar separator impregnated with liquid electrolyte is sandwiched between an anode and cathode with current collectors facilitating the flow of electrons between the electrodes and the external circuit. These compact, multilayer assemblies are typically encased in formats such as coin cells, rectangular prismatic cells, pouch cells, or cylindrical cells. However, these standardized geometries impose limitations, making it challenging to integrate batteries seamlessly into unconventional applications, often resulting in unused or dead-volumes. In an attempt to deviate from two-dimensional battery architectures, the use of additive manufacturing (AM) technologies has been investigated, as it potentially enables the development of batteries that maximize spatial efficiency while meeting the specific needs of nontraditional applications by providing enhanced power performances.

A considerable amount of recent research efforts on the topic are dedicated to demonstrating the 3D printing of nonspecific shape-conformable batteries with adequate electrochemical performance. In this context, material extrusion techniques as well as vat photopolymerization or also powder bed fusion processes have been investigated. Most reported studies predominantly concentrate on the development of material feedstocks for the printers, with particular emphasis on electrode design and fabrication. Although the separator appears as a critical component in batteries, requiring it to be an electronic insulator while exhibiting sufficient microporosity for effective liquid electrolyte impregnation and ionic conductivity, research on the AM of separators remains until now limited.

In commercial lithium-ion batteries, the separator microporous membranes such as Celgard are typically made from polyolefins like polyethylene (PE) and/or polypropylene (PP). Standard separators are less than 30 μm thick, with pore sizes ranging from 0.03 to 0.1 m. In monolayer separators made of either PE or PP, extreme heat causes the polymer to melt, closing the pores. This pore closure acts as an internal safety mechanism, reducing the risk of thermal runaway in the battery. To enhance this safety feature, tri-layer separators were developed, consisting of a PE layer sandwiched between two PP layers. In this configuration, the PE layer, with a lower melting temperature (130° C.), melts and seals the pores during overheating, effectively shutting down the battery. The outer PP layers, with a higher melting temperature (150° C.), remain solid, providing a more robust physical barrier compared to monolayer designs. Commercially available separators are often manufactured by means of an extrusion process where the micropores will be created through the subsequent mechanical stretching of the thinly extruded polymer membrane. To date, commercially available separators from Celgard represent the standard for microporosity, so their pore uniformity and shape establish a performance baseline by which additively manufactured separators are compared.

However, the traditional mechanical stretching method used to create micropores in commercial 2D separators is not feasible for 3D-printed separators. Unlike 2D extruded polymer membranes, which are uniform and continuous, 3D-printed structures are formed layer by layer, resulting in inherent anisotropy and weaker interlayer bonding. Attempting to mechanically stretch a 3D-printed separator to induce porosity would likely lead to deformation, delamination, or even fracture of the printed item. Furthermore, the high precision and intricate geometries enabled by 3D printing make it incompatible with post-processing techniques like stretching, as these processes could compromise the dimensional accuracy and mechanical integrity of the separator.

For 3D printing separators, the most commonly explored AM technique to date remains a form of material extrusion known as direct ink writing (DIW) or also sometimes referred as Liquid Deposition Modeling (LDM) in literature. Its cost-effective and highly-loadable nature lends itself nobly to separator manufacturing. However, DIW faces serious architectural restrictions during printing from the effects of gravity on low viscosity inks. As a result, DIW is limited to producing 2D planar shapes, meaning nontraditional battery architectures with complex geometries in the z-axis (like overhangs for example) must be prepared using alternative processes. In spite of this, DIW does possess the unique advantage of solvent evaporation during post processing leading to micropore formation, a feature critical to the success of battery separators.

### SUMMARY

There is a need for the following embodiments of the present disclosure. Embodiments include 3D printing of microporous separators via fused deposition modeling and thermally induced phase separation. Of course, the present disclosure is not limited to these embodiments.

According to an embodiment of the present disclosure, a process comprises: mixing a diluent with a polymer to form a composition comprising a polymer rich phase and a diluent rich phase; forming a shape comprising the composition; separating at least a portion of the diluent rich phase from at least a portion of the polymer rich phase within the shape; and selectively dissolving preferentially within the shape at least a portion of the diluent rich phase relative to the polymer rich phase using a solvent. According to another embodiment of the present disclosure, a composition of matter comprises: a mixture comprising a polymer rich phase and a diluent rich phase, wherein at least a portion of a polymer rich phase is separated from at least a portion of the diluent rich phase to define a porosity; and a solvent in contact with the mixture. According to another embodiment of the present disclosure, an apparatus comprises: a lithium ion battery separator preform comprising a mixture comprising a polymer rich phase and a diluent rich phase, wherein at least a portion of a polymer rich phase is separated from at least a portion of the diluent rich phase to define a porosity; and a solvent in contact with the mixture.

These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings (wherein identical reference numerals (if they occur in more than one view) designate the same elements).

FIGS. 1A-1C show schematic illustrations showcasing the process to manufacture a solvent-free porous membrane through fused deposition modeling and thermally induced phase separation in accordance with embodiments of the present disclosure.

FIGS. 2A-2B show a polypropylene/paraffin wax filament prepared via extrusion in accordance with embodiments of the present disclosure.

FIGS. 3A-3F show a), c) and e) digital files; and b), d) and f) experimentally 3D printed polypropylene/paraffin wax items in accordance with embodiments of the present disclosure.

FIG. 4 shows a polypropylene item obtained after soaking 3D printed polypropylene/paraffin wax in petroleum ether solvent to promote paraffin wax removal. Note that the complex shape obtained through the 3D printing process is retained while the remaining structure exhibits high porosity in accordance with embodiments of the present disclosure.

FIGS. 5A-5B show an FDM-3D printed complex lattice design manufactured using the polypropylene/paraffin wax 60:40 weight % filament feedstock: a) as-printed; b) item obtained after soaking in petroleum ether that promoted the paraffin wax phase removal and porosity creation. As shown, the 3D printed complex structure is perfectly retained in accordance with embodiments of the present disclosure.

FIG. 6 shows results of tensile testing of the 3D printed polypropylene/paraffin wax 40:60 weight % composition in accordance with embodiments of the present disclosure.

FIG. 7 shows tensile testing of the 3D printed PP:PW 40:60 wt % composition after soaking in petroleum ether. This after soaking structure is now highly porous due to the PW phase removal in accordance with embodiments of the present disclosure.

FIG. 8 shows stability test results for 3 different composition ratios via linear sweep voltammetry (LSV) characterization of the 3D printed separators after soaking in petroleum ether in accordance with embodiments of the present disclosure.

FIG. 9 shows galvanostat (amperostat) cycling characterization of 3D printed separators after soaking in petroleum ether. As shown, the manufactured porous samples are functional in a real 18 mm diameter form factor lithium-ion battery environment to be used as the “separator” component in accordance with embodiments of the present disclosure.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well-known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

In an embodiment, polypropylene (PP) and paraffin wax (PW) were mixed together. Three distinct PP:PW compositions 30:70, 40:60, and 60:40 weight ratio (wt. %) were prepared. Solvent-free filament extrusion of a ~1.75 mm diameter 3D printable filament was performed using an unmodified commercially available Filabot Original EX2 extruder (Filabot Triex LLC, United States) by homogeneously feeding a composition batch into the hopper under a fume hood. It is important to note that the preparation through extrusion of such a PP:PW filament could alternatively be performed with any other commercially available single-screw or double-screw extruder (such as but not limited to Haake Thermofisher MiniLab extruder, Filabot EX6 extruder, Collin extruder, etcetera).

The prepared filament was subsequently employed as material feedstock for a standard commercially available Fused Deposition Modeling (FDM) 3D printer. Here, the FDM 3D printer was an Original Prusa i3 MK3S+(Prusa Research, Czech Republic). It is important to note that the 3D printing of such a PP:PW filament could alternatively be performed with any other commercially available FDM 3D printer (such as but not limited to Bambu Lab printers, Creality Ender, Markforged, Flashforge, Stratasys FDM printers, etcetera).

Through the FDM 3D printing process, items with any complex shape can be manufactured. As a proof of concept, our team was able to 3D print items with any shape (including simple foils, more complex ASTM D638 Type V tensile specimens for subsequent tensile testing, as well as a highly complex lattice) to demonstrate/showcase the custom filament's printability of any complex 3D shape. After this step, the 3D printed items (also called separator in the context of energy storage applications such as lithium-ion batteries) are not porous and still contain both PP and PW.

To induce the microporosity, the as-printed items were placed in a flask containing petroleum ether. The items were left agitating overnight to allow the petroleum ether to preferentially dissolve the PW-rich phase. This resulted in PP items of any complex shape exhibiting high porosity. Through image analysis, it was determined that the porosity of these samples is approximately 43% (the other approximately 57% volume being occupied by the remaining PP polymer matrix), and that pore size ranges from 42 nm diameter (mesopores) and up to 2.227 μm diameter (macropores). We also think that smaller micropores (<2 nm) are also present although not detected by the employed image analysis of a SEM image. Transmitting Electron Microscopy (TEM) can confirm the presence of micropores (<2 nm).

Embodiments can include a broad range of PP:PW compositions ranging from approximately 20:80 to approximately 95:5 (wt. %). For example, embodiments can include PP:PW compositions including 30:70, 40:60, and 60:40 weight ratio (wt. %).

Depending on the PP:PW, we expect that the mechanical properties and porosity can be tuned on-demand and thus adapted to a specific commercial application. In this context, we expect that a broad range of mechanical performances and porosity can be achieved.

For example, ultimate tensile stress can range from approximately 7 MPa to approximately 500 MPa. As another example, Young's modulus can range from approximately 100 MPa to approximately 1600 MPa. As another example, porosity % can range from approximately 1% and up to 80% volume.

Porosity size: from micropores (approximately 1 nm diameter) to macropores (approximately 20 μm diameter).

Additives such as ceramic particles, carbonaceous materials, metal particles, and/or plasticizers can be added to the proposed composition to provide some additional functionality to the system or improve the mechanical/flexural performances.

Ceramics additives can be between approximately 0% and approximately 40% wt. of the total composition. Ceramic additives can include TiO₂, SiO₂, Al₂O₃, ZnO, CeO₂, BN, AlN, Si₃N₄, SiC, B₄C, WC, CaCO₃, BaSO₄, MoS₂ and/or WS₂.

Carbonaceous additives can be between approximately 0% and approximately 40% wt. of the total composition. Carbonaceous additives can include graphene, graphite, Carbon Nanotubes (CNTs), Carbon fibers, Carbon nanofibers and/or Carbon Black.

Metals additives can be between approximately 0% and approximately 90% wt. of the total composition. Metal additives can include Aluminum (Al), Copper (Cu), Silver (Ag), Gold (Au), Nickel (Ni), Iron (Fe), Titanium (Ti), Zinc (Zn), Tungsten (W), Molybdenum (Mo), Cobalt (Co), Chromium (Cr), Magnesium (Mg), Silicon Carbide (SiC), Boron Carbide (B₄C), Silver Nanoparticles (AgNPs), Gold Nanoparticles (AuNPs), Copper Nanoparticles (CuNPs), Nickel Nanoparticles (NiNPs), Iron Nanoparticles (FeNPs), Metallic Glasses (Fe-based or Zr-based amorphous alloys), Metal Hydrides (e.g., MgH₂, TiH₂), alloys (such as stainless steel), Shape Memory Alloys (NiTi—Nitinol) and/or High-entropy-alloys.

Plasticizers can be between approximately 0% and approximately 40% wt. of the total composition. Plasticizers can include Di(2-ethylhexyl) phthalate (DEHP), Diisononyl phthalate (DINP), Diisodecyl phthalate (DIDP), Butyl benzyl phthalate (BBP), paraffin oil, Di-n-butyl phthalate (DBP), Dioctyl terephthalate (DOTP), Diisononyl cyclohexane-1,2-dicarboxylate (DINCH), Trioctyl trimellitate (TOTM), Acetyl tributyl citrate (ATBC), Epoxidized soybean oil (ESO), Polyethylene glycol (PEG), Polyethylene glycol dimethyl ether (PEGDME), Glycerol, Triethyl citrate (TEC), Dibutyl sebacate (DBS), Di(2-ethylhexyl) adipate (DEHA), Triphenyl phosphate (TPP), Diisooctyl phthalate (DIOP), Dioctyl adipate (DOA), Diisononyl adipate (DINA), Tributyl citrate (TBC), 2,2,4-trimethyl-1,3-pentanediol diisobutyrate (TXIB), Butyryl tri-n-hexyl citrate (BTHC), Neopentyl glycol diacrylate (NPGDA), Triethylene glycol diacrylate (TEGDA), Diglycidyl dimethacrylate (DGDMA), Epoxidized soybean oil (ESO), Maleated epoxidized soybean oil (MESO), Polypropylene glycol (PPG), Sorbitol, Citrates, Sebacates, Adipates, Phosphates, Sulfonamides, Polybutenes, Castor oil derivatives, Alkyl sulfonates, Chlorinated paraffins, Epoxidized linseed oil, Polymeric plasticizers, Trimellitates, Glyceryl triacetate, Acetylated monoglycerides, Polycaprolactone-based plasticizers, Succinates, Maleates, Benzoates, Diethyl phthalate (DEP), Dibutyl phthalate (DBP), Tri-n-butyl citrate (TBC), Ethyl hexyl glycerin, Polydimethylsiloxane (PDMS), Polyether polyols, Propylene carbonate, Laurates, Glycol ethers, and/or various oligomeric and/or polymeric plasticizers.

While the data below relates to PP:PW mixtures (with PP as a polymer, PW as a diluent) with petroleum ether as a solvent to remove the PW-rich phase and thus create the microporosity into the 3D printed structure of any shape, embodiments can be based on other polymers, diluents and solvent systems. it is expected that the proposed approach will also work with other polymers, diluents and solvents that are listed in Table 1 below.

In the combination of a polymer/diluent system, at least one polymer, one diluent, and one solvent is the minimum necessary combination to employ thermally induced phase separation (TIPS) as a technique to create the porosity. Polymer/diluent systems exist where multiple polymers are used, multiple diluents are used, or multiple solvents are used. Any combination of the below categories can yield a TIPS product.

TABLE 1
Polymers, diluents and solvents.

| Polymers | Diluents | Solvents |
|---|---|---|
| Polypropylene | paraffin wax (PW) | petroleum ether |
| polyethylene (PE) | liquid paraffin (LP) | ethanol |
| poly (ether ether ketone) | diisodecyl phthalate | hexane |
| (PEEK) | (DIDP) | benzene |
| polyvinylidene fluoride | soybean oil (linoleic acid, | heptane |
| (PVDF) | oleic acid, palmitic acid, | xylene |
| polysulfone (PSF) | linolenic acid, stearic | ether |
| poly(ethylene-co-vinyl | acid, arachidic acid, | ethylene glycol |
| alcohol (EVOH) | palmitoleic acid, lauric | cyclohexane |
| polyvinylpyrrolidone | acid, myristic acid) | cyclohexanone |
| (PVP) | polyetherimide (PEI) | kerosene |
| Polyethylene oxide (PEO) | diethylene glycol | ethyl acetate |
| polyvinyl butyral (PVB) | dibenzoate (DEDB) | polyethylene glycol |
| pluronic F127 (F127) | dibutyl phthalate (DBP) | (PEG) |
| polyacrylonitrile (PAN) | polyethylene glycol | toluene |
| polylactic acid (PLA) | (PEG)/polyethylene oxide | tetrahydrofuran |
| poly(methyl methacrylate) | (PEO) | methylene chloride |
| (PMMA) | dimethyl sulfone | trichlorotrifluoroethane |
| cyanoacrylate (CA) | sulfolane | (Freon113) |
| cellulose acetate | cyclohexane | dichloromethane |
| polyamide nylon | γ-butyrolactone (γ-BL) | (DCM) |
| (PA(Nylon)) | propylene carbonate (PC) | chloroform |
| polyphenylene sulfide | ethylene glycol | N-methyl pyrrolidone |
| (PPS) | monoethyl ether acetate | (NMP) |
| polystyrene (PS) | (CABA) | dimethylacetamide |
| ethylene- | glyceryl triacetate (GTA) | (DMAc) |
| chlorotrifluoroethylene | glycerol diacetate | acetone |
| (ECTFE) | castor oil | water |
| polymethylpentene (PMP) | dioctyl adipate (DOA) | deionized (DI) water |
| polyoxymethylene (POM) | diglycol | Acetonitrile |
| polyvinyl chloride (PVC) | dimethyl phthalate | Dimethylformamide |
| Acrylonitrile butadiene | (DMP) | 2-propanol |
| styrene (ABS) | dibenzylidene sorbitol | methanol |
| Polyethylene terephthalate | (DOS) | dimethylsulfoxide |
| (PET) | cyclohexanone (CO) | (DMSO) |
| Polyethylene terephthalate | dibutyl sebacate (KD) | methyl ethyl ketone |
| glycol (PETG) | di 2-ethyl hexyl phthalate | propylene glycol |
| polyether sulfone (PES) | (DEHP) | methyl ether |
| high density polyethylene | acetyl tributyl citrate | other polar solvents |
| (HDPE) | (ATBC) | other nonpolar solvents |
| poly(ethylene-block- | acetyl triethyl citrate | other aprotic solvents |
| ethylene glycol) (PE-b- | (ATEC) | other protic solvents |
| PEG) | triethyl citrate (TEC) | |
| polyethylene oxide-co- | triethyl phosphate (TEP) | |
| polypropylene oxide-co- | diethylene glycol | |
| polyethylene oxide (PEO- | monoethyl ether acetate | |
| PPO-PEO) | (DCAC) | |
| polytetrafluoroethylene | PolarClean | |
| (PTFE) | triethylene glycol (TEG) | |
| Hyflon | triethylene glycol | |
| poly(1-lactic acid) (PLLA) | diacetate (TEGDA) | |
| polycaprolacton (PCL) | ε-caprolactam | |
| polycaprolactam (Nylon 6) | | |
| as well as co-polymers | | |

Alternative methods for introducing porosity, such as incorporating sacrificial materials, controlled extrusion parameters, or selective curing strategies (such as leveraging solvent evaporation) during the printing process, can be employed to achieve the desired microporous structure in 3D-printed separators.

On the other hand, the filament material extrusion process (also referred to in the literature as Fused Deposition Modeling (FDM) or Fused Filament Fabrication (FFF)) appears as an option of choice for 3D printing shape-conformable batteries and geometrically-complex separators thanks to its ability to print 3D structures with less limitations in the z-axis. Another advantage is the affordable cost of desktop printers and the wide commercialization of multi-material options that could enable the printability of the full battery in a single step in the future. In spite of its many alluring features as a 3D printing technique, FDM's most glaring drawback, in the context of manufacturing battery separators, is the inability to naturally produce microporosity. FDM's nature precludes microporosity formation as a result of printed feedstock cohering to previous passes during its layer by layer application of filament. Resultantly, application of FDM to print battery separators remains an underexplored field of research.

In this context, achieving microporosity is essential for optimizing the performance of additively manufactured separators produced by FDM. A high density of submicron pores is desirable as it facilitates the liquid electrolyte impregnation that is required to achieve an adequate ionic conductivity through the separator membrane. Since these pores function as channels for the ions to diffuse between both electrodes, the inherently nonporous nature of FDM-printed structures can hinder ion mobility, leading to ion trapping and capacity fading. This limitation of FDM highlights the suitability of thermally induced phase separation (TIPS) as a viable solution.

TIPS involves cooling a homogenous high-temperature solution composed of a polymer and diluent, causing phase separation into a solid two-phase structure. As the solution cools below a bimodal solubility temperature and enters a metastable region in its phase diagram, differences in surface energy will cause the polymer and diluent to demix, where nucleation and growth becomes the driving mechanism for the formation of a dispersed diluent-rich phase in a polymer-rich matrix. Once phase separation occurs, the diluent-rich phase (also referred to as the polymer-lean phase in this disclosure) can be selectively removed using an extractant, yielding a porous polymer membrane. By carefully tuning parameters such as composition, cooling rate, and the specific polymer/diluent system (PDS), a range of reproducible pore morphologies can be achieved.

Based on this framework, this disclosure aims to investigate the production and optimization of an FDM-3D printable biphasic filament, specifically designed to be used as a separator in a lithium-ion battery after being 3D-printed and subjected to a post-processing step promoting the formation of micropores leveraging the TIPS. While studies have explored FDM and TIPS independently for separator fabrication, none have combined their advantages to enable the straightforward production of a highly porous, 3D printable battery separator with complex 3D geometries. This study introduces and investigates an innovative process that integrates both techniques to overcome existing limitations. Three different PP/paraffin wax (PW) filament compositions are prepared, and their impact on the microstructure and porosity of the 3D-printed separators is analyzed. The resulting morphology is characterized using SEM, while mechanical properties are assessed through tensile testing, and electrochemical performance is evaluated via electrochemical impedance spectroscopy, linear sweep voltammetry and galvanostatic cycling. Finally, the capability of this protocol to fabricate 3D complex shapes is demonstrated by producing a highly porous separator featuring a sophisticated lattice design.

### Example

Specific exemplary embodiments will now be further described by the following, nonlimiting example which will serve to illustrate in some detail various features. The following example is included to facilitate an understanding of ways in which embodiments of the present disclosure may be practiced. However, it should be appreciated that many changes can be made in the exemplary embodiments which are disclosed while still obtaining like or similar result without departing from the scope of embodiments of the present disclosure. Accordingly, the example should not be construed as limiting the scope of the present disclosure.

### Filament Preparation

Polypropylene (PP) pellets (with GR10SPP grade) and paraffin wax (PW) pellets were purchased from Braskem and Sigma-Aldrich, respectively. Three distinct PP:PW compositions 30:70, 40:60, and 60:40 weight ratio were prepared in batches of 20 grams. For example, for the 30:70 composition using 30 wt % of 20 g would amount to 6 grams of PP and 70 wt % of 20 grams total amounts to 14 grams for a total weight composition of 20 grams. Solvent-free filament extrusion of a ~1.75 mm diameter 3D printable filament was performed using a Filabot Original EX2 extruder (Filabot Triex LLC, United States) by homogeneously feeding a composition batch into the hopper under fume hood. The extruder's temperature remained fixed at 160° C. across all filament preparation, a value arrived at experimentally and further supported by TGA analysis. The prepared filament was manually spooled using a large beaker covered in masking tape, an alteration made as a result of the filament's wax content not adhering to glass, for ease of handling and storage. Before each filament extrusion, the extruder was purged at 162° C. for at least 20 minutes to clean the barrel.

### Printing

Fused deposition modeling (FDM) was completed under fume hood using an Original Prusa i3 MK3S+ (Prusa Research, Czech Republic). Printed models were created using Fusion360 (Autodesk, United States) then sliced through the PrusaSlicer (Prusa Research, Czech Republic). To account for the custom filament's unique preparation and properties during 3D printing, the following altered printing parameters were employed: 0.6 mm nozzle diameter, 220° C. nozzle temperature, 80° C. bed temperature, 30 mm/s solid infill print speed, and a 1.4× filament extrusion multiplier. Besides the aforementioned alterations, all other printing parameters are consistent with the “0.15 mm QUALITY @0.6MK3” system preset. Additionally, the printing plate was altered by adding masking tape to ensure proper print bed adhesion. Multiple models were developed for testing the three different filament compositions. This includes single layer sheets, ASTM D638 Type V tensile specimens, and a custom geometrically complex lattice. The single layer print was employed to perform subsequent electrochemical battery cycling as well as the ionic conductivity testing. Separator discs (18 mm and 12.7 mm diameter) were obtained by mechanically punching the 3D printed single layer sheets. The tensile specimens were used for mechanical tensile testing. Ten dogbones of each composition were 3D printed with a view to soak five in petroleum ether (solvent employed to create the microporosity through PW removal) and leave five unsoaked to understand the impact of the microporosity induction onto the mechanical strength. Lastly, the lattice was created to showcase the custom filament's printability of any complex 3D shape. An important observation made was that the more wax content in the filament the printability quality is sacrificed.

### Microporosity Induction

To induce microporosity, the as-printed separators were placed in a flask containing petroleum ether (ACS reagent, Sigma-Aldrich) under a fume hood. The separators were left agitating overnight to allow the petroleum ether to preferentially dissolve the PW-rich phase in the disc. Then, the as-soaked separators were removed from the solvent to air dry under the fume hood for 1 hour before being dried overnight in an 80° C. oven to remove any residual moisture. The aforementioned procedure was followed exactly on as-printed tensile specimens and lattices to induce microporosity resulting in as-soaked tensile specimens and lattices.

### Structural and Mechanical Characterization

Scanning electron microscopy was performed using a Hitachi SU3500 (Hitachi, Ltd., Japan). All imaging required sputter coated (MSE Supplies, USA) for analysis under high vacuum, operating between 5-10 kV, using a secondary electron detector. Cross sectional analysis of the separator and filament required submerging samples in liquid nitrogen (LN) and subsequently splitting normal to the print line direction and normal to the filament's length to reveal the sheet's undeformed profile and filament cross section, respectively.

Tensile testing was performed in accordance with ASTM D638. Ten specimens of each composition were prepared: 5 as-printed and 5 as-soaked tensile specimens. Testing was performed using an Instron Machine (Instron, USA) at a 10 mm/min testing speed per ASTM standard.

### Electrochemical Characterization

LFP electrodes were prepared on an aluminum foil current collector using a material extrusion, direct-ink-write 3D printing process using N-Methyl-2-pyrrolidone (NMP, Sigma Aldrich) solvent, then dried overnight at 70° C. to yield a film with ~4.5 mg/cm² of active material (LFP, Skyspring Nanomaterials, Inc). The LFP electrode contained 80 wt % of active material, 10 wt % polyvinylidene fluoride (PVDF, Solvay 5130), and 10 wt % carbon black (Super P, TIMCAL) in the dried state.

Coin cell preparation took place in a MBRAUN UNIlab pro glove box (MBRAUN Inc., United States) under an argon environment with <0.1 ppm H₂O and O₂. Prior to assembly, as-soaked separator samples were immersed into 1 M LiPF₆ in ethylene carbonate and diethyl carbonate (EC/DEC 1:1 wt. %) electrolyte (LP40) overnight, resulting in fully prepared as-impregnated separators. Coin cell assembly required preparing as-impregnated separators between metallic lithium and LFP electrodes supplied by Sandia National Laboratory with an additional 150 μL of LP40 before 1 ton of pressure was applied to seal the coin cell using a Compact Digital Pressure Controlled Electric Crimper-MSDK-160E (MTI Corporation, United States).

Test samples for linear sweep voltammetry (LSV), galvanostatic cycling, and rate capability cycling were left running for a total of approximately 200 cycles.

Potentiostatic electrochemical impedance spectroscopy (PEIS) testing was prepared by loading a 12.7 mm diameter as-impregnated separator between stainless steel (SS) electrodes using Swagelok products (Swagelok Co., United States). Arbin Instruments and Gamry Instruments technology was used to measure ionic conductivity (a) across a frequency range from 1 Hz to 2×10⁶ Hz and an AC amplitude of 50 mV. Using equation 1, a was calculated, where A is the area of contact between the separator and electrodes, t is the separator membrane's thickness, and R_{b} is the bulk impedance. To calculate this the system uses the phase shift from the applied AC potential and the resulting current response at different frequencies. This determines how much lag the current has from the Voltage at different frequencies.

$$σ = \frac{1}{A} \cdot \frac{t}{{R}_{b}}$$

### Solvent-Free 3d Printable Filament Extrusion

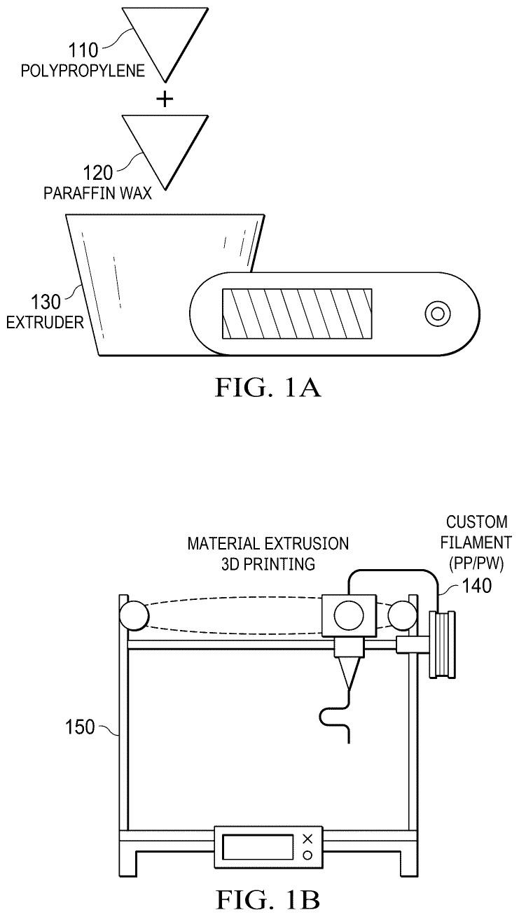

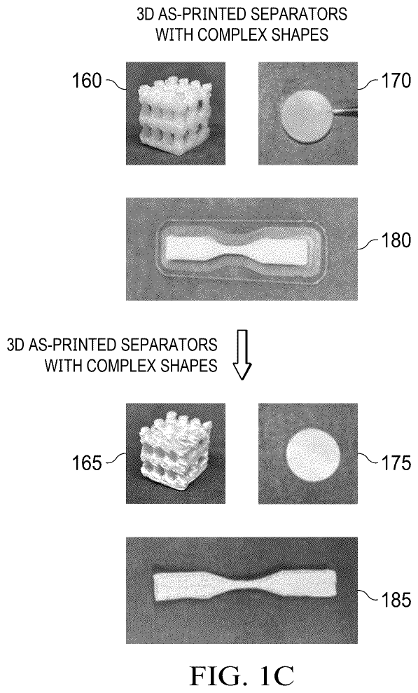

As illustrated in FIGS. 1A-1C, a number of steps contribute to the 3D printing of separator membranes, but the novel custom composition filament formulation requires only a single step. FIGS. 1A-1C are schematic illustrations showcasing the process to manufacture a solvent-free porous membrane through fused deposition modeling and thermally induced phase separation. Referring to FIG. 1A, polypropylene 110 is mixed together with paraffin wax 120. The mixture is processed through extruder 130 without solvent to form a filament. Referring to FIG. 1B, custom filament 140 is additive manufacturing processed with a 3D printer 150. Referring to FIG. 1C, 3D as-printed separators with complex shapes 160, 170, and 180, are further processed with petroleum ether to produce devices 165, 175, and 185.

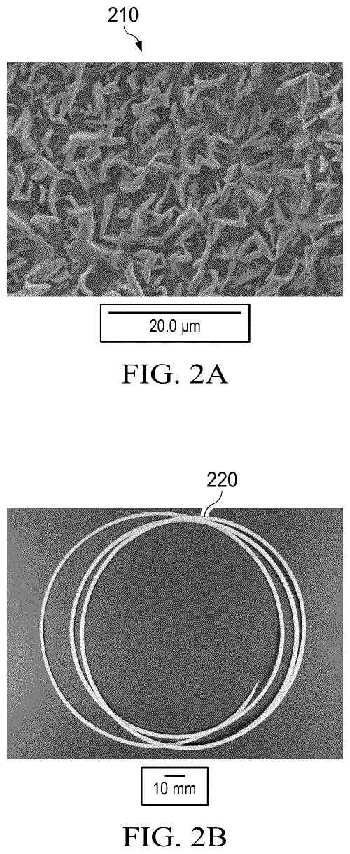

Three aforementioned compositions with fixed PP/PW ratios are examined and compared in the present study: “30:70,” “40:60,” and “60:40.” Preparation of each composition's filament began with combining and stirring 20 g total of feedstock pellets into the hopper of the Filabot Original EX2 extruder at 160° C. for a process known as melt mixing. As the pellets move through the heated barrel, they melt and form a solvent-free homogeneous solution that cools into a 1.75 mm diameter filament as it passes through the extruder's die. Through procedural repetition, a pattern emerged: as the weight content of wax increases between compositions, the yield of total usable filament decreases. A phenomenon coined as “wax bleed out” would occur in later stages of filament fabrication, where the wax content would become too liquidous to produce harvestable filament. This likely stems from the extruding temperature being too high for the increased paraffin wax content, with a melting temperature between 43° C. and 95° C. Experimentally, any extruding temperature below 160° C. yielded un-melted PP still in its pellet form being fed through the extruder resulting in a nonhomogeneous filament of varying diameter. Interestingly, the process of creating filament by heating and cooling the PDS is the first instance during the membrane production process where TIPS occurs. The miscible components form a homogenous solution within the extruder's heated barrel at 160° C., and phase separation occurs when the solution's temperature drops below its compositional binodal line as it cools at the extruding nozzle. The resulting structure 210, visualized in FIG. 2A, is a plethora of paraffin wax flakes interspersed within a polypropylene matrix. FIG. 2B shows polypropylene/paraffin wax filament 220 prepared via extrusion.

### 3D Printing Parameter Optimization and Microporosity Fabrication

Following the preparation of the custom composition filament, determining optimal 3D printing parameters became the subject of interest. The first attempt at printing, a single-layer sheet measuring 65 mm×65 mm in length and width, revealed a detrimental print defect. “Macrotears,” or visually apparent decohesions between adjacent passes of feedstock application, began forming unpredictably during printing. Consequently, viable separator membranes could not be punched from the printed sheet for fear that the gaps could lead to dendrite formation or short circuiting when assembled in a coin cell. To improve the sheet's print quality, a number of printing parameters were experimentally adjusted within the printer's software and studied to understand their effects. These altered printing parameters, outlined in Table 2, led to a higher quality product by various means. For example, PP has a well-documented propensity for shrinking and warping during printing, resulting in poor print bed adhesion. To prevent sheets from detaching, the bed's temperature was increased from 60° C. to 80° C., a value further corroborated by published investigations like that of Spoerk et al. Additionally, the filament extrusion multiplier value was changed from 1.0× to 1.4×. Increasing this parameter accounts for inhomogeneities in filament diameter, compared against commercial filaments, ensuring adequate feed rate to prevent under extrusion and macrotears. Similarly, the nozzle's speed was reduced during solid infill printing to reduce residual stress, a hypothesized contributing factor to macrotear formation. The combined efforts of all the aforementioned altered printing parameters successfully led to the eradication of macrotears as a defect. Another explored printing parameter involved the 3D printer's nozzle temperature. Experimentally, it was discovered that printing at any temperature below 180° C. led to nozzle clogging and inextrusion. For this reason, special interest was invested into optimizing the nozzle temperature. Replicas of a printed 10 mm×10 mm×2.5 mm coupon were printed at 180° C., 190° C., 200° C., 210° C., and 220° C. and studied to understand the nozzle temperature's effect on print quality. A visual examination reveals a higher density of pores before and after soaking in petroleum ether for samples printed at 220° C.

Outside of the slicing software's tunable parameters, a number of measures were employed to additionally ensure a high quality product. Most notably, a layer of painter's tape was placed on the print bed's surface prior to printing. This minute change served primarily to increase PP's bed adhesion, but also inadvertently aided in reducing the distance between the nozzle and print surface, resulting in a thinner membrane. Additionally, the printed sheet's dimensions were optimized to prevent filament waste. The original sheet, a 65 mm×65 mm square, yields up to 9 separator discs of 18 mm diameter, leading to a total wasted area of 1,935 mm². Conversely, using the updated dimensions, a 62 mm×22 mm sheet, to punch 3 separator discs led to only 601 mm² of wasted print area. By reducing waste of printed real estate, filament could more effectively be utilized.

TABLE 2
Printing parameters altered during optimization and their effects.

| Printing | Original | | Altered | | |
|---|---|---|---|---|---|
| Parameter | Value | | Value | | Effect |
| Nozzle Diameter | 0.4 | mm | 0.6 | mm | Increased print speed and strength |
| Nozzle Temperature | 215° | C. | 220° | C. | Improved printability and “print- |
| | | | | | induced porosity formation.” |
| Bed Temperature | 60° | C. | 80° | C. | Reduced risk of print bed detachment |
| | | | | | and warping. |
| Solid Infill Print | 80 | mm/s | 30 | mm/s | Prevented print line decohesion and |
| Speed | | | | | “macrotears.” |
| Filament Extrusion | 1.0x | | 1.4x | | Improved filament flow, print |
| Multiplier | | | | | homogeneity, and reduced |
| | | | | | macrotears. |

Parameter optimization was done at different stages throughout the fabrication of the custom filaments and printed specimens. The temperature parameter was determined experimentally and parameters like printer calibration and using the live adjust Z to print the sheets as thin as possible were done during the printing phase. The last parameter optimization was the separator sheet size pictured below. When trying to print a large sheet, macro-tears were very common. To fix this it was decided to print the sheet with the dimensions of 22 mm×62 mm rather than the larger dimension of 65 mm×65 mm. The shorter the distance that the printing nozzle had to travel showed better results as shown in the smaller separator sheet.

Taking the temperature that the filament was extruded at as a baseline temperature for what the filament could be printed with, through experiments several temperatures were evaluated for printing. This ranged between 180° C.-220° C. The printer's most common printing temperature for polymers started at 215° C. When using this temperature option, the printed sheets experienced large macro tears due to nozzle temperature and filament thickness inconsistencies. Printing optimization for the as-printed separators was done experimentally. Starting with temperature changes such as nozzle and printing bed temperature. Standard temperatures for printing with PP materials typically range between 220-250° C. for the nozzle and 85-90° C. for the bed. Standard temperatures for the nozzle and printing plate would need to range between 140-150° C. for the nozzle and needs a bed temperature of 80-90° C. for proper adhesion of the single layer sheets. Similarly, printing speed was found experimentally, using the printing speed recommended through data sheets was too fast for the custom filament developed. Using the faster printing speed caused large tears throughout the single layer printed sheet which is termed as “macro-tears”. This speed was reduced which showed minor improvements in the print. It did show less macro-tears; however, these tears were still present. The next parameter that was changed was the flow rate of the filament through the nozzle. Though this showed further improvements in the subsequent sheets, this showed over extrusion on the surface.

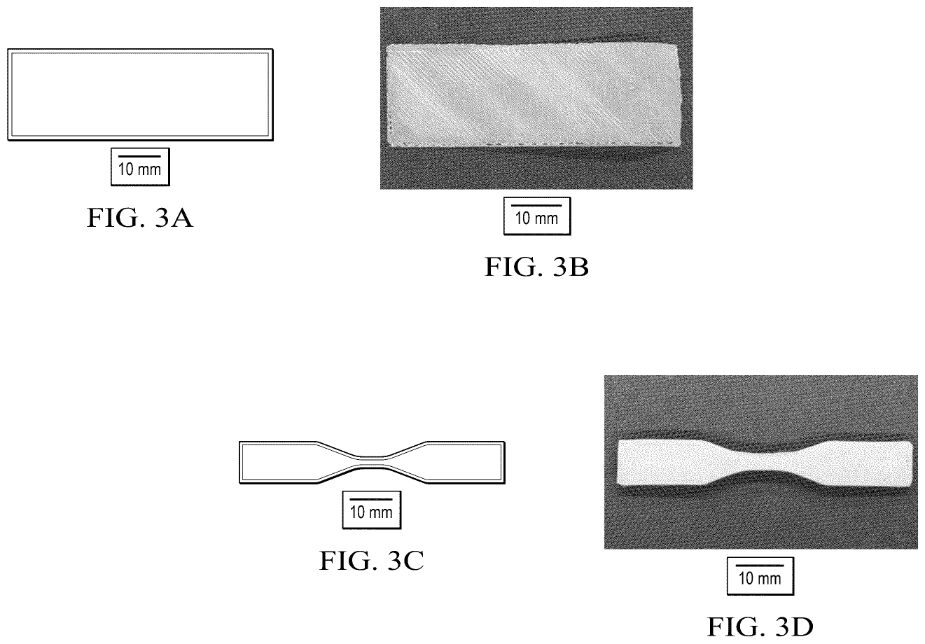

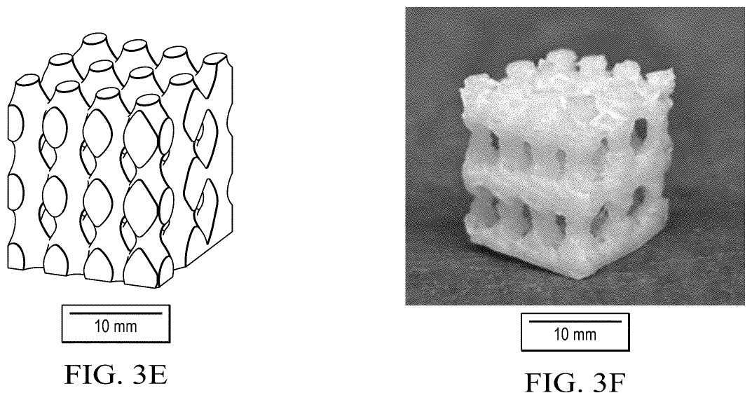

Through the FDM 3D printing process, items with any complex shape can be manufactured as shown in FIGS. 3A-3F. Embodiments are able to 3D print items with any shape (including simple foils, more complex ASTM D638 Type V tensile specimens for subsequent tensile testing, as well as a highly complex lattice) to demonstrate/showcase the custom filament's printability of any complex 3D shape. After this step, the 3D printed items (also called separator in the context of energy storage applications such as lithium-ion batteries) are not porous and still contain both PP and PW. FIGS. 3A-3F show a), c) and e) digital files, while b), d) and f) are corresponding experimentally 3D printed PP/PW items.

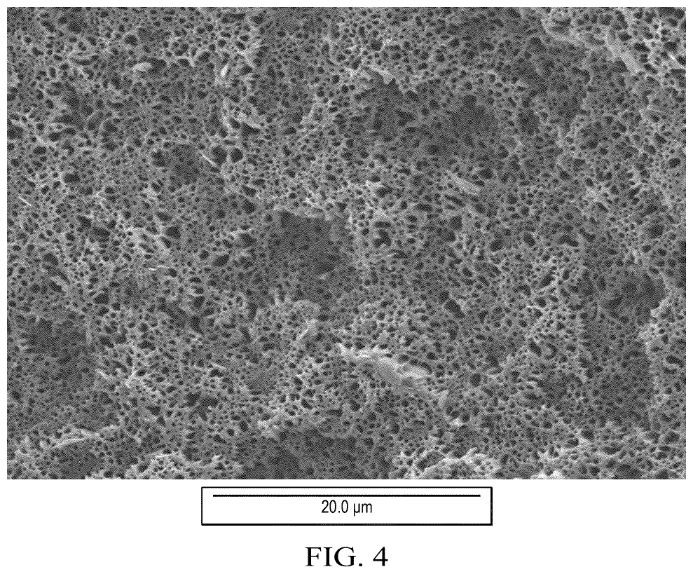

Finally, to induce the microporosity, the as-printed items were placed in a flask containing petroleum ether. The items were left agitating overnight to allow the petroleum ether to preferentially dissolve the PW-rich phase. This resulted in PP items of any complex shape exhibiting high porosity as shown in FIG. 4. Through image analysis, it was determined that the porosity of these samples is around 43% (the other 57% volume being occupied by the remaining PP polymer matrix), and that pore size ranges from 42 nm diameter (mesopores) and up to 2.227 μm diameter (macropores). We also think that smaller micropores (<2 nm) are also present although not detected by the employed image analysis of a SEM image. TEM can confirm the presence of micropores (<2 nm). FIG. 4 shows resulting PP that is highly porous obtained after soaking an example of the 3D printed PP/PW items in the petroleum ether solvent to promote the PW removal. Note that the structure now exhibits high porosity.

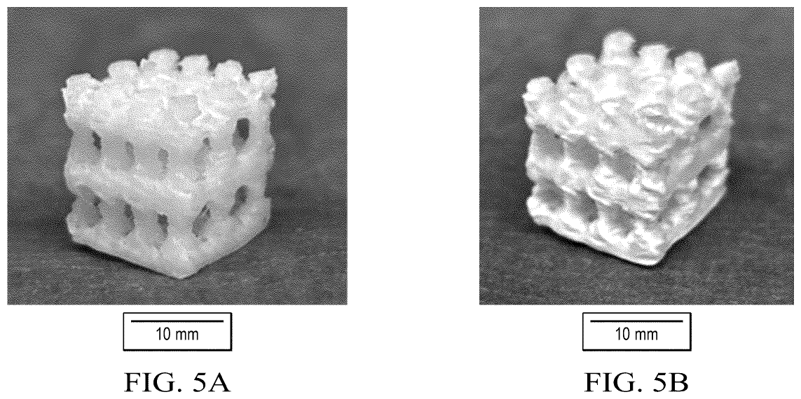

The color change that the printed specimens experience after they have been soaked is an important factor to note. While the as-printed items are translucent, the as-soaked separators show a significant color change from being soaked in petroleum ether and appear opaque. This is due to the solvent molecules interacting with the polymers chemical structure. This causes a change in the electron configuration which subsequently changes the amount of light that can pass through the polymer. This color change further shows how effective the solvent has been in removing the wax and leaving the polypropylene with a microporosity structure. Importantly, the 3D printed complex structure is perfectly retained, as shown in FIGS. 5A-5B, even after being soaked in petroleum ether to promote the porosity creation through the PW phase removal. FIGS. 5A-5B show an FDM-3D printed complex lattice design manufactured using the PP/PW 60:40 wt % filament feedstock: a) as-printed; b) item obtained after soaking in petroleum ether that promoted the PW phase removal and porosity creation. As shown, the 3D printed complex structure is perfectly retained.

### Impact of Sample Composition on Mechanical Performance and Printability

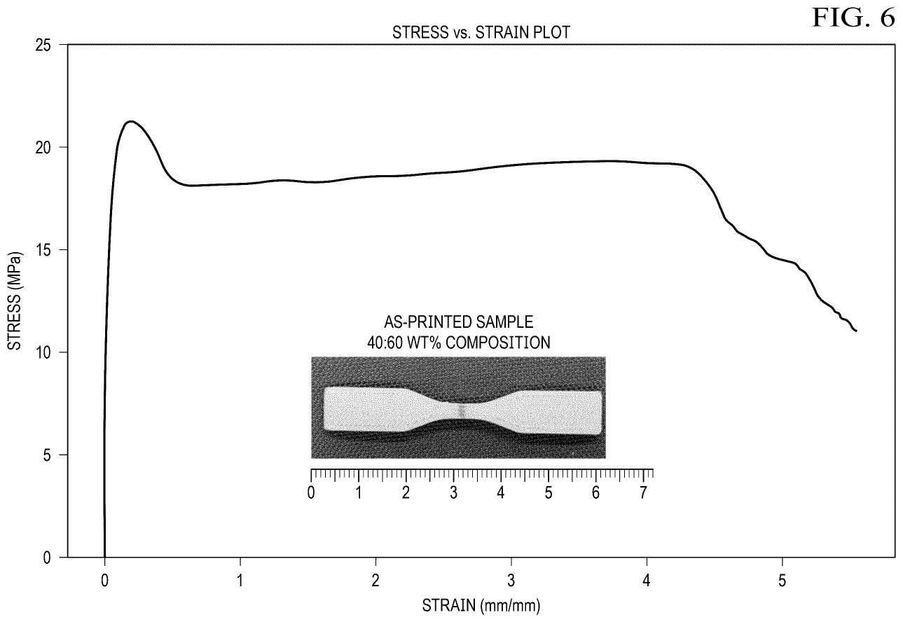

Tensile testing of the samples revealed that soaking in petroleum ether significantly impacts the printed filament's properties. Tensile testing of the 40:60 unsoaked specimen, which contained both PP and PW phases in its cross section, yielded an ultimate tensile strength (UTS) of 21.23 MPa and an elastic modulus of 303.52 MPa as shown in FIG. 6. FIG. 6 shows tensile testing of the 3D printed PP:PW 40:60 wt % composition.

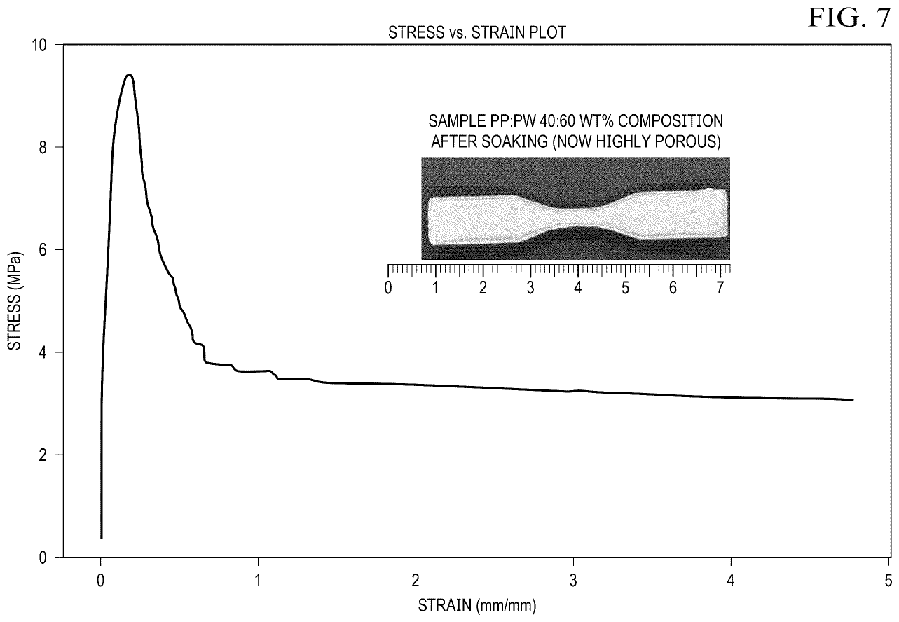

Conversely, the soaked sample's mechanical properties were negatively influenced by the extraction of the PW phase using petroleum ether. Upon testing, the soaked 40:60 sample returned a UTS of 9.41 MPa with an elastic modulus 66% lower than its unsoaked counterpart of 100.95 MPa as shown in FIG. 7. Since soaking in petroleum ether overnight removed the wax content of the soaked specimens, their cross sectional area, consisting of many micropores, could not withstand the same applied forces, resulting in poorer mechanical properties. FIG. 7 shows tensile testing of the 3D printed PP:PW 40:60 wt % composition after soaking in petroleum ether. The structure is now highly porous due to the PW phase removal.

### Composition Impact on Electrochemical/Battery Performance for 3D Printed Separators

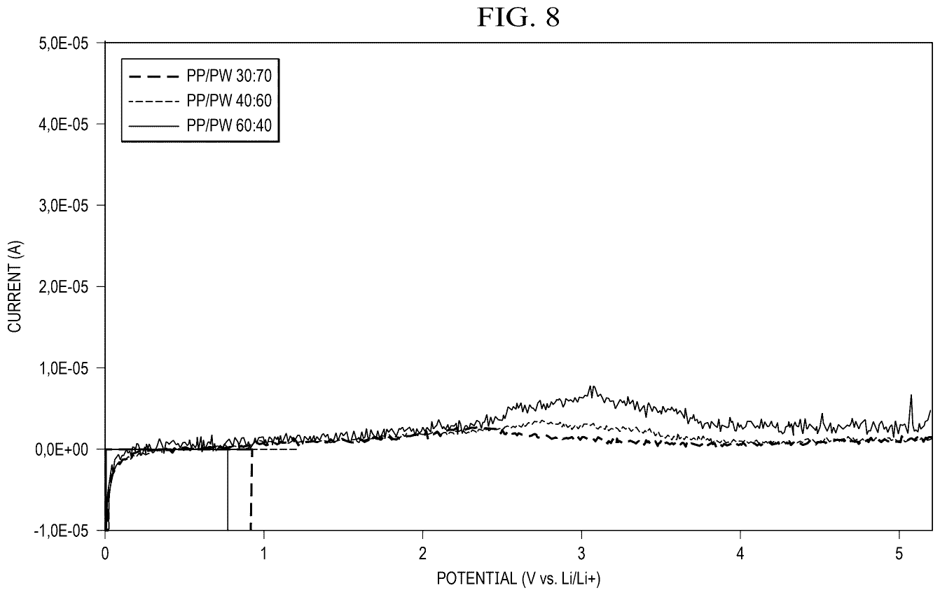

As shown in FIG. 8, the highly porous samples exhibit good stability through a wide voltage window (0 to 5 V). FIG. 8 shows stability tests via Linear Sweep Voltammetry (LSV) characterization of the 3D printed separators after soaking in petroleum ether.

On the other hand, cycling testing reveals the true performance capability of a battery. For cycling, lithium iron phosphate electrodes (LFP) were employed against a Li-0 electrode during testing, meaning specific capacity values as high as [175 mAh/g] are achievable.

The above galvanostatic cycling test, completed at a rate of C/20, compares the performance of all three custom compositions against two commercially available separators, Celgard and a glassy fiber separator. One notable trend between commercial options versus the custom separators is the slope of the lines. The slope of the black, red, and blue cycling plots, flatter in nature, reveal a slower decay in specific capacity performance as opposed to the slopes of the green and purple cycling plots. The difference in slopes reveals a telling conclusion: separators manufactured using FDM and TIPS retain a better specific capacity across numerous cycles as opposed to commercial alternatives. Between the three custom compositions, an interesting pattern emerged: a decrease in polymer content—and by extension, an increase in porosity-did not lead conclusively to an increase in specific capacity performance. Two likely theories justify this trend. The difficulty of printing a highly waxy composition like 30:70 inadvertently led to a thicker separator. A difference of even 50 μm when printed sheets were as thin as 150 μm could mean a 33% thicker membrane, and a resultantly poorer performance. However, the difference in thickness is entirely unnoticeable when manually managing samples, making quality control difficult between samples. Conversely, compositions with higher polymer content were easier to print with, typically printing similarly to commercially available PP filaments, and could effectively print the single layer with the desired thickness.

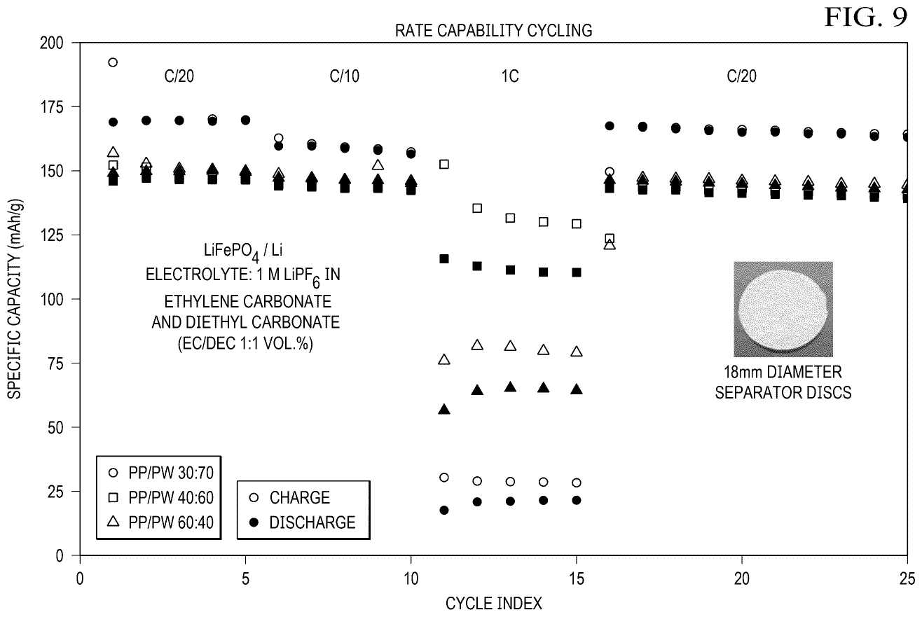

Cycling testing to highlight rate capability was performed as follows: 5 cycles at C/20, 5 cycles at C/10, 5 cycles at C/1 (aka 1C), followed again by unending cycles at C/20 as shown in FIG. 9. This demonstrates that the manufactured porous samples are functional in a real lithium-ion battery environment to be used as the “separator” component. FIG. 9 shows galvanostating cycling characterization of the 3D printed separators after soaking in petroleum ether. As shown, the manufactured porous samples are functional in a real lithium-ion battery environment to be used as the “separator” component.

Still referring to FIG. 9, the emerging trend amongst the three samples operates as expected: an increase in porosity, by means of decreasing polymer content, results in stronger performance. The 30:70 sample, which contains 25% and 50% less polymer content than the 40:60 and 60:40 samples respectively, maintains a sharp performance lead across the first 10 cycles at C/20 and C/10. The opposite, however, becomes true only for the tested C/1 rate. The 30:70 composition's specific capacity plummets to less than 25 mAh/g for 5 cycles at C/1, a roughly ~85% reduction in performance, before recovering upon returning to C/20. This propensity for crashing at a C/1 rate is inversely related to polymer content. To further illustrate this point, the 40:60 and 60:40 compositions see a performance decrease of ~55% and ~20% respectively.

### CONCLUSIONS

This disclosure establishes and investigates the production and optimization of an FDM-3D printable separator filament of novel composition capable of bio-inspired microporosity formation through the means of fused deposition modeling (FDM) and thermally induced phase separation (TIPS) as a technique to create the porosity. Although numerous reports have applied either FDM or TIPS as techniques by which separators can be manufactured, none have leveraged the combined advantages of both to enable facile fabrication of a printable, highly porous battery separator, with any complex 3D shape. As such, the innovative process is introduced and examined in the present study. Through the characterization and comparison of three custom ratios of PP to paraffin wax as the polymer and diluent respectively, the impact of applying TIPS and FDM to create microporosity via wax extraction is investigated. To the best of the authors' knowledge, no current phase diagram exists showcasing the solubility of paraffin wax in polypropylene. As such, this present study further examines the viability of this polymer/diluent system by comparing the compositional effect on pore morphology, mechanical properties, electrochemical performance, and printability. Further development of this technique, which requires only a single post-processing step, can yield a scalable, promising alternative to commercialized batteries with applicable use in single battery printing and shape conformable battery production. The full extent to which this process can be applied has yet to be realized; additional meaningful applications extend beyond AM rechargeable batteries including but not limited to microfiltration/ultrafiltration or even bone tissue engineering.

### Practical Applications

There are virtually innumerable uses for embodiments of the present disclosure. Some of these practical applications are detailed below.

Practical applications of embodiments include energy & batteries. Embodiments can be used in lithium-ion batteries, sodium-ion batteries (and other battery chemistries), in fuel cells, and redox flow batteries for ion transport. Porous polymer films are commonly used in batteries for separator components. These play an important role for proper ion movement between positive and negative ends while also preventing short circuits. This promotes thermal and chemical stability within the battery cells.

Practical applications of embodiments include water treatment. Porous polymeric membranes are crucial in urban wastewater treatment as they function as filtration membranes, trapping contaminants while allowing clean water to pass through. The precise pore structure enhances the removal of heavy metals, bacteria, and organic pollutants.

Practical applications of embodiments include water filtration. Porous films are integral to reverse osmosis membranes, selectively allowing water molecules to pass while blocking salt and impurities. Their optimized pore structure enhances water permeability and energy efficiency in desalination plants.

Practical applications of embodiments include kidney filtration. Embodiments can be used in dialysis, drug delivery systems, tissue engineering, and artificial lungs. Polymer membranes with controlled porosity enable the selective separation of blood components, ensuring efficient removal of harmful substances while retaining essential elements. Pore size and distribution control the filtration process, preventing clogging and improving overall performance in dialysis and other medical applications.

Practical applications of embodiments include artificial lungs. In artificial lungs, polypropylene (PP) porous membranes function as gas exchange interfaces, mimicking the role of alveolar membranes in natural lungs. Their key role is to diffuse oxygen (O₂) into the blood and remove carbon dioxide (CO₂), enabling oxygenation in patients with severe respiratory failure.

Practical applications of embodiments include medical and healthcare. Sterile wraps for wound dressings are made of porous polymer films that allow for sterilization gases or steam to penetrate while keeping bacteria and contaminants out. This ensures that medical instruments remain sterile until they are used in clinical settings.

Practical applications of embodiments include pharmaceuticals. Embodiments can be used in drug purification, sterile filtration, and bioprocessing. Controlled porosity in polymer films also allows for the regulated release of drugs, ensuring sustained and targeted medication delivery. This improves therapeutic efficiency by reducing side effects and maintaining optimal drug concentration over time.

Practical applications of embodiments include biotechnology. Porosity in polymer films is essential for tissue engineering as it facilitates cell attachment, proliferation, and nutrient exchange. The interconnected pores allow for the diffusion of oxygen and waste removal, promoting healthy tissue growth.

Practical applications of embodiments include dairy processing (e.g., ultrafiltration for protein concentration) and storage. The adaptability of polypropylene films ensures milk remains safe, fresh, and efficiently processed for consumers. Modified polypropylene films with controlled porosity can regulate gas exchange and moisture levels, preventing condensation inside milk pouches and reducing spoilage.

Practical applications of embodiments include wine and beer clarification. Polypropylene membranes, characterized by their selective permeability, play a pivotal role in enhancing wine quality across multiple processes. The use of these films effectively removes suspended solids and colloids, resulting in a clearer wine without the need for chemical agents.

Practical applications of embodiments include microelectronic fabrication. Ultrapure water production and chemical filtration are critical in chip manufacturing. Porous polymer films also play a role in microelectronics by providing insulation and reducing dielectric constant values. This helps improve signal transmission speed and lowers power consumption in integrated circuits.

Practical applications of embodiments include semiconductor foundries. In the semiconductor industry polymeric films ensure that manufacturing processes remain free from microscopic contaminants that could damage sensitive electronic components.

Practical applications of embodiments include military and defense. Embodiments can be made into military grade composites. Polymers offer a lightweight, chemical resistance, thermal stability properties with relatively low cost for uniforms as well as aircraft and vehicle coatings.

Practical applications of embodiments include chemical processing and petrochemicals. Embodiments can be used for fuel, gas separation, solvent recovery, and polymer purification. More recently polymer membranes have been of interest for use in high pressure gas separation uses due their high performance and selectivity and permeability.

Practical applications of embodiments include environmental applications. Embodiments can be used in gas filtration, air purification, and waste remediation. The porosity of polymer films determines their ability to trap dust, allergens, and harmful particles while maintaining airflow. These films are widely used in HVAC systems, face masks, and industrial air purification.

Practical applications of embodiments include textile dyeing wastewater treatment such as removal of dyes, heavy metals, and microplastics from textile industry effluents. Utilizing polymer membrane porosity, water used during textile processing can now be recycled. Separating the pollutants such as chemicals and dyes from water used in textiles significantly reduces the amount of water needed in industrial textile settings.

Practical applications of embodiments include textiles and wearable technology such as breathable waterproof fabrics and smart membranes are primarily composed of polymeric composites. These membranes play a crucial role in enhancing comfort, protection, and functionality in products designed for skin contact and fluid management.

Practical applications of embodiments include metal and ore extraction. Embodiments can be used in solvent extraction, electrowinning, lithium recovery, rare earth element separation, and sustainable mining processes. Porous films are used in sensors to detect harmful heavy metals like mercury by enabling the selective adsorption of metal ions. Their high surface area enhances sensitivity, making detection faster and more efficient.

Practical applications of embodiments include oil and gas. Embodiments can be used in water treatment during the manufacturing of oil and gas, gas separation (e.g., CO₂ removal), and hydrocarbon purification. Gas storage systems also use porous polymer films to allow proper degassing to prevent explosions and fires.

Practical applications of embodiments include hydrogen production and storage. Embodiments can be applied in hydrogen purification, proton exchange membranes (PEMs) for fuel cells, and gas separation. Using polymer films with high porosity allows for the absorption of hydrogen for processing. The pores in these films trap the hydrogen and have the potential for high gravimetric hydrogen storage capacity.

Practical applications of embodiments include agriculture and irrigation such as desalination for irrigation water, pesticide filtration, and controlled-release fertilizers. Sintered polypropylene filters are commonly used due to the ability to change its pore size through different post-processing methods.

Practical applications of embodiments include pulp and paper such as chemical recovery and process water purification. Using porous membranes during manufacturing allows for selective removal of particles and contaminants from the paper slurry. These membranes are used in processes like ultrafiltration and microfiltration to reach different quality of paper products.

Practical applications of embodiments include construction and infrastructure such as waterproofing membranes, concrete curing membranes, and air filtration in buildings. Polymer impregnation in concrete to enhance structural properties like compressive and tensile strength. Waterproofing coats are used to cover set concrete sections by using polymeric composites.

Practical applications of embodiments include cosmetics such as filtration of active ingredients, emulsions, and purification of water used in formulations. Polymers are often used in cosmetics to form protective barriers to prevent bacterial growth or contamination. Porous polymeric films are also used in the production of cosmetics and personal care to filter out unwanted particles from formulas.

Practical applications of embodiments include personal care such as feminine hygiene products that use polypropylene membranes to ensure absorption, leakage protection, and comfort. Other personal hygiene products use these same polymers for baby wipes, makeup remover wipes, and disinfectant wipes to keep the fibers from shedding and tearing.

Practical applications of embodiments include disposable protective wear. Embodiments can be used in face masks (N95, surgical masks) as bacterial and particle filters. Serve as barrier layers in medical gowns and gloves, preventing contamination while maintaining comfort.

Practical applications of embodiments include adult diapers and disposable underwear. Embodiments can be used to provide discreet, comfortable, and absorbent wearables. Forms breathable layers that reduce sweating and skin irritation. Function as moisture barriers to prevent leaks.

Practical applications of embodiments include automotive, and transportation uses such as membranes for fuel cells, emission control, and air filtration systems in vehicles. Etched polymer membranes can relieve pressure, allow cooling, and protect sensitive systems from the external environment. Porous membranes can filter and separate substances to be selective about what is passing through like proton exchange.

Practical applications of embodiments include space exploration. There are virtually innumerable space exploration uses for embodiments of the present disclosure, some of which are detailed here.

Practical space exploration applications include water recycling and filtration. In closed-loop water systems aboard the International Space Station, water must be filtered and purified for reuse. Polypropylene membranes are used in microfiltration and ultrafiltration systems to remove bacteria, particulates, and contaminants, making wastewater drinkable.

Practical space exploration applications include fuel and propellant filtration. Impurities in liquid fuels can cause engine malfunctions or reduce efficiency. Polypropylene membranes help filter fuels and oxidizers to maintain high purity levels. Increase in fuel cell performance using porous polymer materials.

Practical space exploration applications include cryogenics. Embodiments can be used in gas separation for air revitalization in spacecraft, cryogenic liquid filtration, and CO₂ removal. Polymer membranes are used in cryogenics primarily for gas separation. To keep certain gases pure like helium, nitrogen, and oxygen, these membranes function as a protective barrier to be selective and only allow wanted substances through and reject others.

Practical space exploration applications include space suits. Spacesuits need breathable yet waterproof layers to manage astronaut sweat and maintain comfort. Polypropylene porous membranes help wick moisture away while preventing water buildup inside the suit.

Practical space exploration applications include thermal control systems. Spacecraft experience extreme temperature variations. Polypropylene membranes, when combined with multi-layer insulation (MLI), help regulate temperature by controlling moisture and gas exchange.

Practical space exploration applications include radiation protection. While polypropylene itself is not a primary radiation shield, multi-layer composites including polypropylene membranes can help reduce radiation exposure by controlling particle penetration and outgassing.

### Advantages

Embodiments of the present disclosure can be cost effective and advantageous for at least the following reasons. Embodiments of the present disclosure improve quality and/or reduce costs compared to previous approaches.

### Definitions

The term compound is intended to mean a substance formed when two or more chemical elements are chemically bonded together, the elements present in ratios with a limited range of variation and characteristic crystal structure. The term phase is intended to mean a limited range of compositions of a mixture of elements (in a thermochemical system), compounds or ingredients throughout which the chemical potential of the mixture varies with composition, and which either changes discontinuously or remains constant outside of that range.

The term uniformly is intended to mean unvarying or deviating very little from a given and/or expected value (e.g, within 10% of). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be conducted and/or achieved. The term distal, as used herein, is intended to mean far, away, spaced apart from and/or non-coincident, and includes spatial situation where specified functions and/or results (if any) can be conducted and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials. Homologous replacements may be substituted for the substances described herein. Agents which are both chemically and physiologically related may be substituted for the agents described herein where the same or similar results would be achieved.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. For instance, feature(s) of one embodiment may be combined with feature(s) of another embodiment. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

What is claimed is:

1. A method, comprising:
mixing a diluent with a polymer to form a composition comprising a polymer rich phase and a diluent rich phase;
forming a shape comprising the composition;
separating at least a portion of the diluent rich phase from at least a portion of the polymer rich phase within the shape; and
selectively dissolving preferentially within the shape at least a portion of the diluent rich phase relative to the polymer rich phase using a solvent.

2. The method of claim 1, wherein forming comprises extruding a filament comprising the composition.

3. The method of claim 2, wherein extruding comprises thermally induced phase separation.

4. The method of claim 2, wherein forming comprises fused deposition modeling using the filament.

5. The method of claim 1, wherein selectively dissolving comprises generating a porosity within the shape.

6. The method of claim 5, wherein selectively dissolving comprises thermally induced phase separation.

7. The method of claim 1, wherein the polymer comprises polypropylene, the diluent comprises paraffin wax, and the solvent comprises petroleum either.

8. The method of claim 7, wherein a weight ratio of polypropylene to paraffin wax is from approximately 30:70 to approximately 60:40.

9. A composition of matter, comprising:
a mixture comprising a polymer rich phase and a diluent rich phase, wherein at least a portion of a polymer rich phase is separated from at least a portion of the diluent rich phase to define a porosity; and
a solvent in contact with the mixture.

10. The composition of matter of claim 9, wherein the porosity comprises micropores of approximately 1 nm diameter to macropores of approximately 20 μm diameter.

11. The composition of matter of claim 10, wherein the porosity comprises a pore size range from approximately 42 nm diameter (mesopores) to approximately 2.227 μm diameter (macropores).

12. The composition of matter of claim 9, wherein the porosity comprises approximately 43% by volume of a shape defined by the mixture.

13. The composition of matter of claim 9, wherein the polymer rich phase comprises polypropylene, the diluent rich phase comprises paraffin wax, and the solvent comprises petroleum either.

14. The composition of matter of claim 13, wherein a weight ratio of polypropylene to paraffin wax is from approximately 30:70 to approximately 60:40.

15. An apparatus, comprising:
a lithium ion battery separator preform comprising
a mixture comprising a polymer rich phase and a diluent rich phase, wherein at least a portion of a polymer rich phase is separated from at least a portion of the diluent rich phase to define a porosity; and
a solvent in contact with the mixture.

16. The apparatus of claim 15, wherein the porosity comprises micropores of approximately 1 nm diameter to macropores of approximately 20 μm diameter.

17. The apparatus of claim 16, wherein the porosity comprises a pore size range from approximately 42 nm diameter (mesopores) to approximately 2.227 μm diameter (macropores).

18. The apparatus of claim 15, wherein the porosity comprises approximately 43% by volume of a shape defined by the mixture.

19. The apparatus of claim 15, wherein the polymer rich phase comprises polypropylene, the diluent rich phase comprises paraffin wax, and the solvent comprises petroleum either.

20. The apparatus of claim 19, wherein a weight ratio of polypropylene to paraffin wax is from approximately 30:70 to approximately 60:40.
